(19) United States
(12) Patent Application Publication
(10) Pub. No.: US 2024/0314589 A1
(43) Pub. Date: Sep. 19, 2024

(54) RANDOM ACCESS CHANNEL CONFIGURATION

(71) Applicant: ZTE Corporation, Shenzhen (CN)

(72) Inventors: Juan LIU, Shenzhen (CN); Yu Ngok Li, Shenzhen (CN); Ziyang Li, Shenzhen (CN); Li Zhang, Shenzhen (CN)

(73) Assignee: ZTE Corporation, Shenzhen (CN)

(21) Appl. No.: 18/670,351

(22) Filed: May 21, 2024

Related U.S. Application Data
(63) Continuation of application No. PCT/CN2021/142339, filed on Dec. 29, 2021.

(51) Int. Cl. H04W 24/02; H04L 5/00; H04L 27/26; H04W 24/10; H04W 74/0833; H04W 76/10

(52) U.S. Cl. CPC H04W 24/02; H04L 5/0051; H04L 27/26025; H04W 24/10; H04W 74/0833; H04W 76/10

(57) ABSTRACT

A configuration of an initial access communication, such as the random access channel (“RACH”) process, is performed for initializing communications and/or synchronizing devices. The RACH format can be modified and configured for improved communications. For example, a RACH preamble can be modified based on multiple groups or measurements with reference signals. The preamble or format can be modified with a modification to the time duration.

### TECHNICAL FIELD

This document is directed generally to wireless communications. More specifically, wireless communication utilizes a configuration of an initial access, such as a random access channel (“RACH”) configuration.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users, including artificial intelligence (“AI”) requirements. As a result, user mobile stations or user equipment (“UE”) are becoming more complex and the amount of data communicated continually increases. Likewise, the quantity and variety of devices communicating over the network is also increasing. The initial access communications that are used for connecting UE with the network is also increasing in complexity. In order to improve communications and meet reliability requirements for the vertical industry as well as support the new generation network service, communication improvements should be made.

### SUMMARY

This document relates to methods, systems, and devices for configuration of an initial access communication, such as the random access channel (“RACH”) process, that is performed for initializing communications and/or synchronizing devices. The RACH format can be modified and configured for improved communications. For example, a RACH preamble can be modified based on multiple groups or measurements with reference signals. The preamble or format can be modified with a modification to the time duration. In some embodiments, the basestation configures PRACH groups, then the UE may choose one of configured group information based on a threshold or control indication. The configured group information may include PRACH format, PRACH SCS, PRACH format or other information to transmit an initial access signal, which may utilize a preamble.

In one embodiment, a method for wireless communication includes determining or transmitting configurations of at least two groups and receiving a signal during an initial access. The initial access comprises a Physical Random Access Channel (“PRACH”) protocol. The configuration comprises at least one of a preamble for PRACH, a PRACH format, a PRACH subcarrier spacing (“SCS”), a RACH Occasion Configure Index, or a PRACH period. The receiving is by a basestation from a user equipment (“UE”), the transmitting is by a basestation to a user equipment (“UE”), determining is by a basestation. The signal establishes communication between the UE and the basestation. The at least two groups comprises legacy information for a first group and new information for a second group. The configurations of the at least two groups includes a difference between the at least two groups in at least a PRACH format, a PRACH subcarrier spacing (“SCS”), a RACH Occasion configure index, or a PRACH period. The method further includes transmitting a reference signal. The determination of the configuration is based on a measurement of the reference signal or a control signaling indication. The reference signal comprises at least one of the following: a primary synchronization signal, a secondary synchronization signal, a channel-state information reference signal, a demodulation reference signal, a phase-tracking reference signal, or a sounding reference signal. The measurement of the reference signal or the control signaling indication is from another communication node or core network, such as beam information, paging information, or positioning information.

In another embodiment, a method for wireless communication includes transmitting a signal during an initial access, and determining a configuration for the initial access based on at least two groups. The initial access comprises a Physical Random Access Channel (“PRACH”) protocol. The configuration comprises at least one of the following: a preamble for PRACH, a PRACH format, a PRACH SCS, a RACH Occasion Configure Index), a PRACH period. The transmitting is by a user equipment (“UE”) to a basestation, the determining is by a UE. The method includes receiving the configuration for the initial access from the basestation by the UE. The signal establishes communication between the UE and the basestation. The at least two groups comprises legacy information for a first group and new information for a second group. The configuration for the at least two groups includes a difference between the at least two groups in at least a PRACH format, a PRACH subcarrier spacing (“SCS”), a RACH Occasion configure index, or a PRACH period. The method further includes receiving a reference signal and reporting the measurement result to basestation. wherein the configuration is based on a measurement of the reference signal or a control signaling indication. The reference signal comprises at least one of the following: a primary synchronization signal, a secondary synchronization signal, a channel-state information reference signal, a demodulation reference signal, a phase-tracking reference signal, or a sounding reference signal. The measurement of the reference signal or the control signaling indication is from another communication node or core network, such as beam information, paging information, or positioning information.

In another embodiment, a method for wireless communication includes inserting, into an initial access format or preamble format, a time duration, and forming an updated initial access format or preamble format that includes the time duration. The initial access comprises a Physical Random Access Channel (“PRACH”) protocol for the format or preamble format. The time duration comprises a change to a gap prefix (“GP”) or a cyclic prefix (“CP”). The change comprises a symbol level.

In another embodiment, a method for wireless communication includes receiving a signal during an initial access, and modifying a configuration for the initial access based on comparing a threshold. The configuration comprises at least one of a preamble for Physical Random Access Channel (“PRACH”), a PRACH format, a PRACH subcarrier spacing (“SCS”), a RACH Occasion Configure Index, or a PRACH period. The threshold is configured by basestation or high layer parameter and is compared with a measurement result of a reference signal. The symbol number of the PRACH format is based on a beam information, a paging information, a system information, or a positioning information. The modifying of the configuration depends on a comparison to the threshold.

In another embodiment, a method for wireless communication includes transmitting a signal during an initial access, and receiving a modification of a configuration for the initial access based on comparing a threshold. The threshold is configured by basestation or high layer parameter and is compared with a measurement result of a reference signal. The modifying of the configuration depends on a comparison to the threshold. The symbol number of the PRACH format is based on a beam information, a paging information, a system information, or a positioning information.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (“RA”) messaging environment.

FIG. 3 shows one embodiment of initial access signaling.

FIG. 4 shows an embodiment of a random access channel (“RACH”) preamble format.

FIG. 5 shows an embodiment of initial access configuration based on groups.

FIG. 6 shows an embodiment of initial access configuration based on reference signals.

FIG. 7 shows an embodiment of initial access configuration with additional time.

FIG. 8 shows an embodiment of initial access configuration with additional time based on reference signals.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

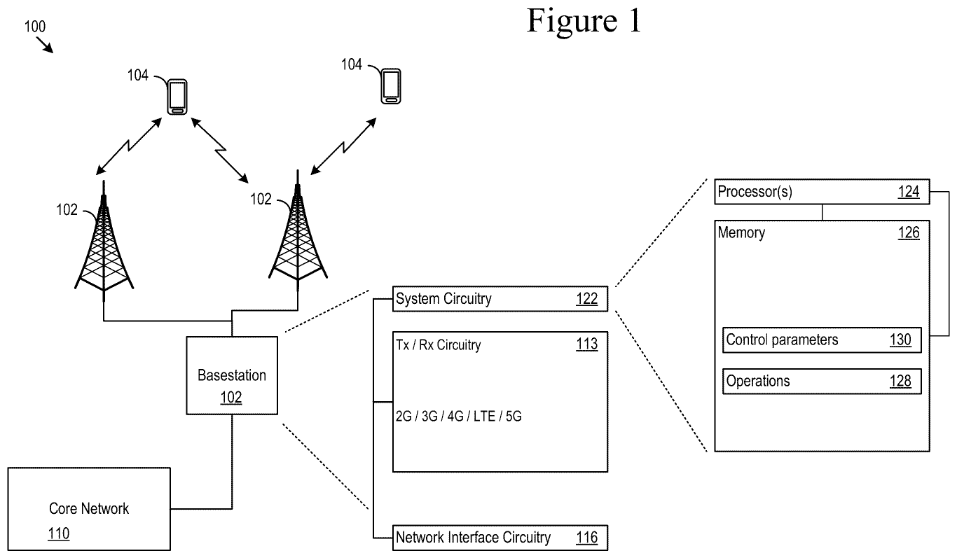

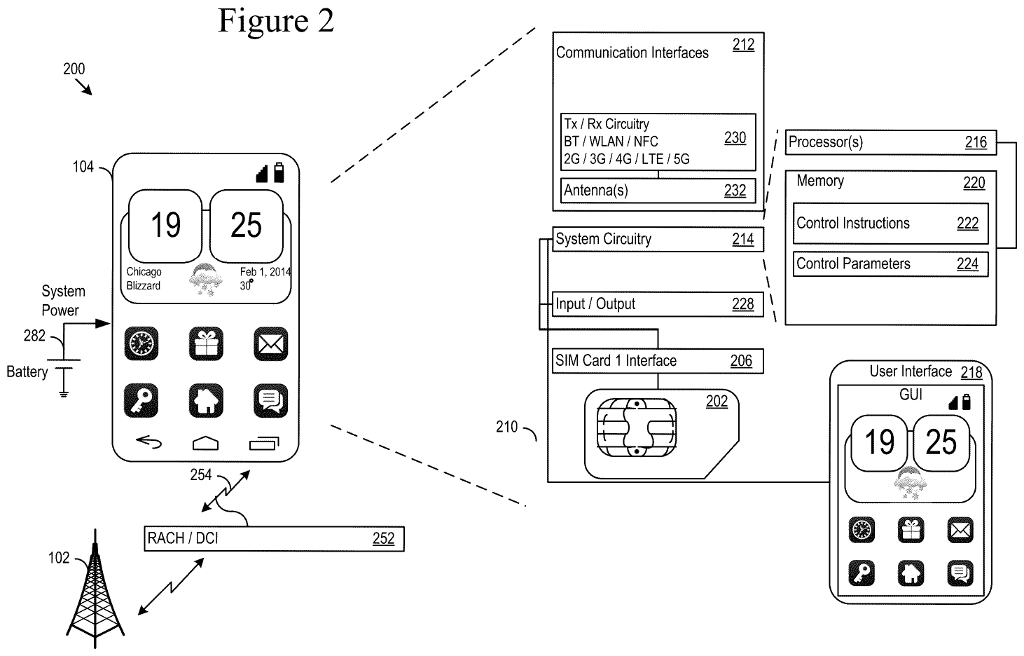

The wireless communications described herein may be through radio access including new radio (“NR”) access. Radio resource control (“RRC”) is a protocol layer between user equipment (“UE”) and the network (e.g. basestation or gNB) at the IP level (Network Layer). There may be various Radio Resource Control (RRC) states, such as RRC connected (RRC_CONNECTED), RRC inactive (RRC_INACTIVE), and RRC idle (RRC_IDLE) state. As described, UE can transmit data through a Random Access Channel (“RACH”) protocol scheme or a Configured Grant (“CG”) scheme or grant scheme. The RACH scheme is merely one example of a protocol scheme for communications and other examples, including but not limited to CG, are possible. The RACH scheme may be used for the initial access process for setting up communications, including synchronization, of the UE and the basestation. FIGS. 1-2 show example radio access network (“RAN”) nodes (e.g. basestations) and user equipment and messaging environments.

Initial access may refer to a process for the UE and the basestation to establish uplink synchronization. One example of this initial access may include Random Access Channel (“RACH”) process or protocol. This process may include obtaining an identification for radio access communication. RACH may include the first message from the UE to the basestation upon being powered on. RACH is a shared channel used by wireless terminals to access the mobile network (TDMA/FDMA, and CDMA based network) for call set-up and data transmission. Whenever a UE wants to make a MO (Mobile Originating) call it schedules the RACH. RACH is a transport-layer channel, while the corresponding physical-layer channel is PRACH. RACH may be part of the initial access for communication between the UE and the network (e.g. basestation).

In addition to providing uplink synchronization, RACH can also be used to obtain the resource for messaging (e.g. RRC Connection Request). The timing between devices may be necessary for proper communication. Accordingly, the timing synchronization between the UE and basestation is established for the communication.

A PRACH preamble may include a specific pattern that may be referred to as a signature. When the UE transmits the preamble, it includes the specific pattern. There may be a limited number of preamble signatures (e.g. 64) among which the UE selects. The PRACH preamble may include data about the timing and frequency domain. The preamble may include different formats from which one is chosen. For example, a PRACH Configuration Index may be used to determine which preamble format to use. PRACH may be used to carry a random access preamble from the UE to the basestation for adjusting uplink timings of the UE in addition to other parameters. The RACH process may be necessary during any of the following conditions: i) Initial access from RRC_IDLE; ii) RRC Connection Re-establishment procedure; iii) Handover; iv) DL or UL data arrival during RRC_CONNECTED when UL synchronization status is “non-synchronized”; v) Transition from RRC_INACTIVE; vi) To establish time alignment at SCell addition; vii) Request for other system information; and/or viii) Beam failure recovery. FIGS. 1-2 show example basestations and UE for communication, such as during initial access with RACH.

FIG. 1 shows an example basestation 102. The basestation may also be referred to as a wireless network node. The basestation 102 may be further identified to as a nodeB (NB, e.g., an eNB or gNB) in a mobile telecommunications context. The example basestation may include radio Tx/Rx circuitry 113 to receive and transmit signaling with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic (system circuitry) 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

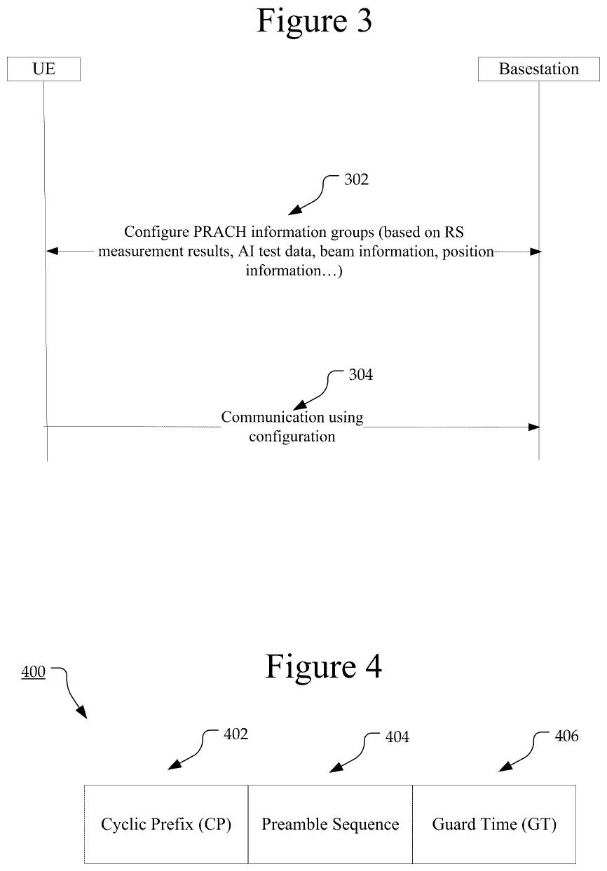

In wireless communication, initial access communication may be through different protocols. In one example, RACH is the initial access communication for setting up and synchronizing the communication between the basestation and the UE. FIGS. 3-8 show various embodiments for modifications to initial access communication, such as changes to RACH.

FIG. 3 shows one embodiment of initial access signaling. The basestation determines a configuration. The configuration in block 302 may be based on information groups, a reference signal determination, a threshold, or other features. In one embodiment, the configuration is for PRACH information groups based on reference signal measurement results, AI test data, beam information, or position information. In this embodiment, the configuration is established by the basestation. The UE can transmit an initial access signal to the basestation. The initial access signal could be sent when the UE is first powered on and is used for initializing and synchronizing the communication between that UE and the basestation. The initial access signal may utilize the established configuration for establishing the communication between the UE and the basestation in block 304. In other words, the configuration is used for the initial access communication which is initiated in block 302. The configuration of the initial access is further described below. While the communication is described as initial access, RACH is one example of such communication and is described in examples below.

FIG. 4 shows an embodiment of a random access channel (“RACH”) preamble format 400. The initial access configuration 302 from FIG. 3 may include modifications or changes to the RACH preamble format 400. In some embodiments, the RACH preamble format 400 may include cyclic prefix (“CP”) 402, a preamble sequence 404, and/or a guard time (“GT”) 406. Further changes to the preamble are described below. The modified or configured RACH format, including the preamble may be referred to as an enhanced format or enhanced preamble.

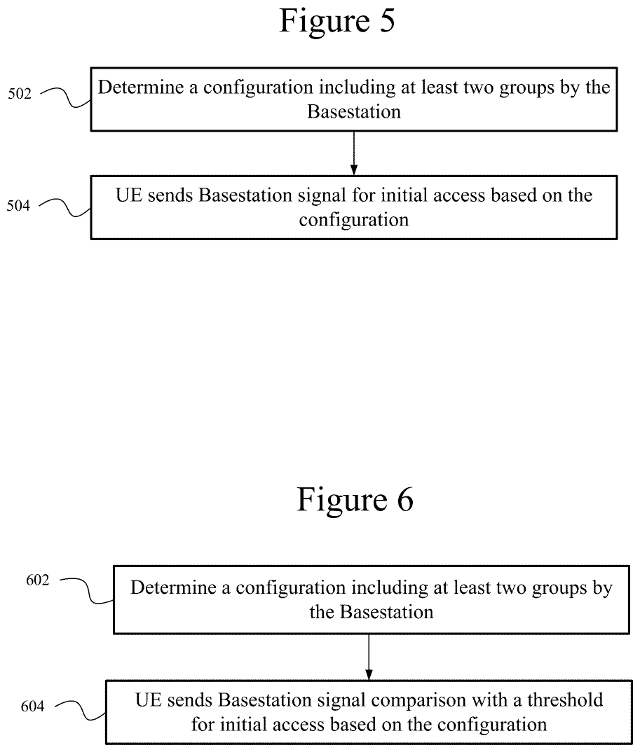

FIG. 5 shows an embodiment of initial access configuration based on groups. A configuration including at least two groups is determined in block 502. As described above, the determination may be performed by the basestation. Specifically, the determination based on groups may include at least two groups for determining or influencing the PRACH format or SCS RACH Occasion (“RO”) configuration (e.g. ConfigureIndex period). The first group information may be a legacy group information, while the second or additional group information may be new. The group information may be designated as group informationN, where N is an integer with group information0 as the legacy version. The different group information may have differences in at least one of following parameters: PRACH format,

PRACH subcarrier spacing (“SCS”), RACH Occasion (“OR”) ConfigureIndex, and/or PRACH period. The mapping ratio of the measurement pool and/or group information can be 1:N, M:1, where N and M are each integers. The measurement pool may include measurements from reference signals as further discussed with respect to FIG. 6. Based on the configuration, the UE sends a basestation a signal for initial access in block 504. The initial access (e.g. RACH) is used for establishing the communication between the basestation and the UE.

The following Tables illustrate various examples of the mapping of a measurement pool to the group information.

TABLE 1
Predefined the match or mapping of measurement
pool and group information.

| Measure result from AI | Group Information |
|---|---|
| Measurement pool0 | group information0 |
| Measurement pool1 | group information1 |
| . . . | . . . |
| Measurement poolN | group informationN |

In some embodiments, the matching of the measurement pools may be to the same groups. While Table 1 illustrated that each measurement pool was based on a different group, Table 2 illustrates multiple measurement pools assigned to the same group.

TABLE 2
Predefined the match or mapping of measurement
pool and group information.

| Measure result from AI | Group Information |
|---|---|
| Measurement pool0 | group information0 |
| Measurement pool1 | |
| Measurement pool3 | group information1 |
| Measurement pool4 | |
| Measurement pool5 | group information2 |
| Measurement pool6 | |
| . . . | . . . |

FIG. 6 shows an embodiment of initial access configuration based on reference signals. In some embodiments, the basestation determine the configuration of initial access communication in block 602 may be further based on measurement results of reference signals.

A reference signal or control signaling indication may be measured and used for a comparison with a threshold in block 604. The measurement results are from at least one type of reference signal (“RS”). In some embodiments, the RS may include at least one of the following: a SSB RS, a primary synchronization signal (“PSS”), a secondary synchronization signal (“SSS”), a channel-state information reference signal (“CSI-RS”), a demodulation reference signal (“DMRS”), a phase-tracking reference signal (“PTRS”), and/or a sounding reference signal (“SRS”). In other embodiments, the measurement results may be from The information from other communication nodes or core network, such as beam information, paging information, or positioning information.

In some embodiments, the UE may use a basestation configured threshold. An initial access configuration in block 602 is used for a measurement or a comparison with the threshold in block 604. Based on the configuration, the UE sends a signal for initial access to the basestation. The initial access (e.g. RACH) establishes the communication between the basestation and the UE.

Table 3 illustrates how measurement results correspond to PRACH formats in one embodiment. The parameter(s) meet the one of the measurement pool (measurement result set), the measurement pool is predefined and/or measured by AI (artificial intelligence), which may be used for wireless environment characterization.

TABLE 3
Measurement results that are used for different formats.

| Measurement Results of RS or Measurement Pool | PRACH format |
|---|---|
| Result1 of Measurement results of RS | PRACH format1 |
| ResultZ of Measurement results of RS | PRACH formatZ |
| ResultX of Measurement results of RS | PRACH formatX |
| ResultZ of Measurement results of RS and/or ResultY | PRACH formatY |
| of the Measurement pool | |
| ResultW of the Measurement pool | PRACH formatW |
| ResultP of Measurement results of RS and/or ResultQ | PRACH formatZ |
| of the Measurement pool | |
| The information form other communication node or | PRACH formatQ |
| core network | |

As shown in Table 3, the ‘Result1’, ‘Result2’, ‘ResultX’, ‘Result Y’, ‘Result P’, ‘Result Z’,‘Result Q’, . . . refer to the different results. ‘X’, ‘Y’,‘Z’, ‘W’, ‘P’, ‘Q’ are integers and ‘format1’, ‘formatZ’,‘formatX’,‘formatY’, ‘formatW’, ‘formatZ’, ‘formatQ’ . . . refer to the different PRACH formats. The measurement result may refer to the results measured in L1 and/or result after the filter.

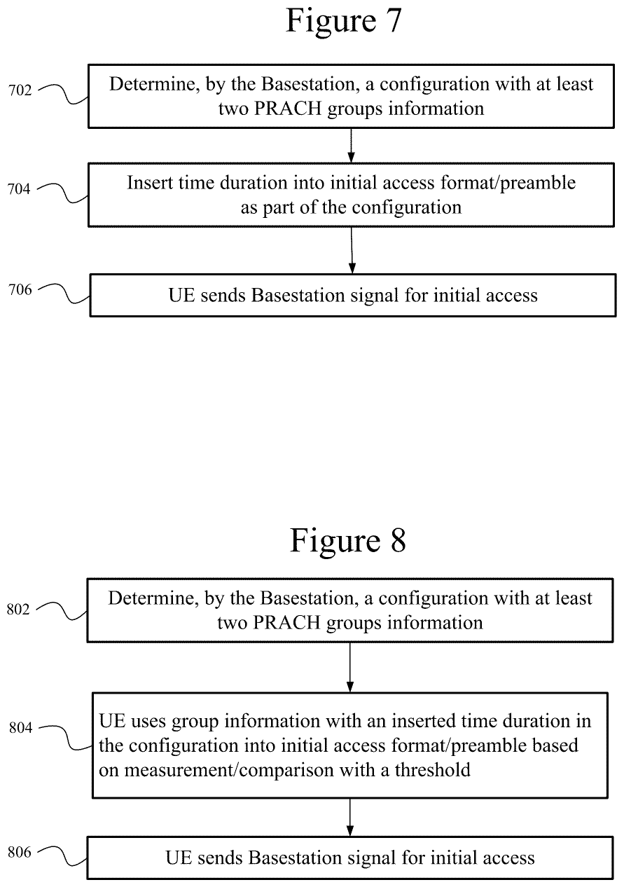

FIG. 7 shows an embodiment of initial access configuration with additional time. An initial configuration is determined for initial access in block 702 including at least two groups information. As discussed above, this configuration may be performed by the basestation and may include PRACH format as one of the parameter in the group configuration and/or may use the threshold to the UE. This initial access configuration may be modified by inserting a time duration into the initial access format and/or preamble in block 704 before the initial access transmission in block 706. The time duration inserted may be referred to as the symbol level. The special time duration added may be to the gap prefix (“GP”) and/or the cyclic prefix (“CP”) for RACH format to form a new PRACH format. FIG. 4 illustrates one example of a PRACH format structure according to one embodiment.

PRACH format may directly define the preamble sequence (Nᵤ in Table 2) and CP, but also the GT may be implicitly indicated. FIG. 4 shows the PRACH structure, the CP and Preamble sequence is the transmission part, the GT part is gap and no transmission in the GT part, which is used for the two adjacent PRACH transmission in two PRACH occasions. In other embodiments, the CP 402 and Preamble Sequence 404 may be the PRACH transmission part.

The time duration added may be referred to as a symbol. In some embodiments, the symbol may refer to (2048+144)*K·2^{-μ}=2192 K·2^{-μ, (}2048+144) K·2^{-μ}+16·K or (2048+512) K·2^{-μ}. In this example, K may be defined as follows: the size of various fields in the time domain is expressed in time units T_{c}=1/(Δƒₘₐₓ·N_{f}) where Δƒₘₐₓ=480·10³ Hz and N_{f}=4096. The constant κ=Tₛ/T_{c}=64 where Tₛ=1/(Δƒ_{ref}·N_{f,ref}), Δƒ_{ref}=15·10³ Hz and N_{f,ref}=2048. The μ for RACH may be according to Table 4 below:

TABLE 4
Supported PRACH transmission numerologies.

| μ | Δf_{RA} = 2μ · 15[kHz] |
|---|---|
| 0 | 15 |
| 1 | 30 |
| 2 | 60 |
| 3 | 120 |
| 4 | 240 |
| 5 | 480 |
| 6 | 960 |

In one embodiment, the symbol level (time duration) is added as shown in Table 5. Specifically, Table 5 illustrates the addition of the symbol level to three entries.

TABLE 5
Symbol level addition.

| | | | | | | N_{CP}^{RA}, | |
|---|---|---|---|---|---|---|---|
| | L_{RA} | | | | | adding | Support |
| | μ | | | | | symbol level | restricted |
| Format | ϵ {0, 1, 2, 3} | μ = 0 | μ = 1 | Δf_{RA} | Nᵤ | gap for CP | sets |
| A1 | 139 | 1151 | 571 | 15 · 2^{μ} kHz | 2 · 2048 κ · 2^{-μ} | 288 κ · 2^{-μ} | — |
| A2 | 139 | 1151 | 571 | 15 · 2^{μ} kHz | 4 · 2048 κ · 2^{-μ} | 576 κ · 2^{-μ} | — |
| A3 | 139 | 1151 | 571 | 15 · 2^{μ} kHz | 6 · 2048 κ · 2^{-μ} | 864 κ · 2^{-μ} | — |
| B1 | 139 | 1151 | 571 | 15 · 2^{μ} kHz | 2 · 2048 κ · 2^{-μ} | 216 κ · 2^{-μ} | — |
| B2 | 139 | 1151 | 571 | 15 · 2^{μ} kHz | 4 · 2048 κ · 2^{-μ} | 360 κ · 2^{-μ} | — |
| B3 | 139 | 1151 | 571 | 15 · 2^{μ} kHz | 6 · 2048 κ · 2^{-μ} | 504 κ · 2^{-μ} | — |
| B4 | 139 | 1151 | 571 | 15 · 2^{μ} kHz | 12 · 2048 κ · 2^{-μ} | 936 κ · 2^{-μ} | — |
| C0 | 139 | 1151 | 571 | 15 · 2^{μ} kHz | 2048 κ · 2^{-μ} | 1240 κ · 2^{-μ} | — |
| C2 | 139 | 1151 | 571 | 15 · 2^{μ} kHz | 4 · 2048 κ · 2^{-μ} | 2048 κ · 2^{-μ} | |

In a further embodiment, the symbol level (time duration) is added as shown in Table 6 with the TCP which is according to the N_{CP}^{RA} in Table 5 and TGP modified by either M or N times the symbol level duration, TSEQ is according to the Nᵤ in Table 5. “N* symbol level duration” refers to the duration being N times of the symbol level duration. “M* symbol level duration” refers to the duration being M times of the symbol level duration. N and M are integers and may be determined based on Table 7 discussed below. This is another embodiment of an enhanced PRACH format.

TABLE 6
Enhanced PRACH format showing the duration modifications.

| Preamble | | #of | | | |
|---|---|---|---|---|---|
| Format | | Sequence | TCP | TSEQ | TGP |
| Enhanced | 1 | 2 | 288(288 + M* symbol level | 4096 | 0(0 + N* symbol level |
| A | | | duration) | | duration) |
| | 2 | 4 | 576(576 + M* symbol level | 8192 | 0(0 + N* symbol level |
| | | | duration) | | duration) |
| | 3 | 6 | 864(864 + M* symbol level | 12288 | 0(0 + N* symbol level |
| | | | duration) | | duration) |
| Enhanced | 1 | 2 | 216(216 + N* symbol level | 4096 | 72(72 + N* symbol level |
| B | | | duration) | | duration) |
| | 2 | 4 | 360(360 + M* symbol level | 8192 | 216(216 + N* symbol level |
| | | | duration) | | duration) |
| | 3 | 6 | 504(504 + M* symbol level | 12288 | 360(360 + N* symbol level |
| | | | duration) | | duration) |
| | 4 | 12 | 936(936 + M* symbol level | 24576 | 792(792 + N* symbol level |
| | | | duration) | | duration) |
| Enhanced | 0 | 1 | 1240(1240 + M* symbol | 2048 | 1096(1096 + N* symbol level |
| C | | | level duration) | | duration) |
| | 2 | 4 | 2048(2048 + M* symbol | 8192 | 2912(2912 + N* symbol level |
| | | | level duration) | | duration) |

FIG. 8 shows an embodiment of initial access configuration including at least two PRACH groups information by the basestation in block 802, the UE uses one of the at least two PRACH groups information, and uses the inserted time duration in the configuration into initial access format/preamble based on measurement or comparison with a threshold in block 804. An initial access configuration with a time duration based on the measurements or based on a comparison with a threshold. Alternatively, the configuration is based on the measurement results which are from at least one type of reference signal (“RS”). In some embodiments, the RS may include a SSB RS, a primary synchronization signal (“PSS”), a secondary synchronization signal (“SSS”), a channel-state information reference signal (“CSI-RS”), a demodulation reference signal (“DMRS”), a phase-tracking reference signal (“PTRS”), and/or a sounding reference signal (“SRS”). In other embodiments, the measurement results may be from the information from other communication nodes or core network, such as beam information, paging information, or positioning information. In some embodiments, the UE may use a basestation configured threshold. An initial access configuration is modified with a time duration based on the measurements or based on a comparison with the threshold in block 804. The time duration (e.g. symbol level) is further discussed above with respect to FIG. 7. An initial access configuration based on reference signals may be modified by inserting a time duration into the initial access format and/or preamble in block 804 before the initial access transmission in block 806.

FIG. 4 was one example of a RACH preamble. The RACH format may be enhanced of modified in different ways. In one embodiment, the PRACH format may not be fixed. The new adding symbol number or the threshold of RSRP/RSRQ may be informed by an RRC parameter, a DCI, system information (SIB1), MAC CE, other high layer parameters, or other control signaling. The new adding symbol number maybe indicated by the beam information, paging information, system information, or positioning information in one embodiment. Table 7 illustrates how positioning information can be used to calculate the distance between the UE and the serving cell. The distance can be compared against a threshold distance value (e.g. X, Y, Z). In other words, the symbol number can be varied based on the distance (i.e. positioning information). Positioning information is merely one example of the information (e.g. reference signal) that can be used for modifying the RACH or setting the symbol number as in Table 7.

TABLE 7
Symbol number determination.

| Use positioning information to calculate the | |
|---|---|
| distance to the serving Cell | symbol number |
| Use positioning information to calculate the distance | M = 1, N = 0 |
| to the serving Cell < X(m) | |
| Use positioning information to calculate the distance | M = 2, N = 0 |
| to the serving Cell < Y(m) | |
| Use positioning information to calculate the distance | M = 2, N = 1 |
| to the serving Cell < Z(m) | |
| 0 <= Use positioning information to calculate the | M = 1, N = 0 |
| distance to the serving Cell < X(m) | |
| X <= Use positioning information to calculate the | M = 2, N = 0 |
| distance to the serving Cell < Y(m) | |
| Y <= Use positioning information to calculate the | M = 2, N = 1 |
| distance to the serving Cell < Z(m) | |

Tables 8-9 further show how positioning information can be used to determine the PRACH configuration. Tables 8 and 9 are different examples of which group information is configured. As with Table 7, the values for X, Y, and Z follow 0<X<Y<Z.

TABLE 8
PRACH configuration based on positioning information.

| Positioning information to calculate | |
|---|---|
| distance to the serving Cell | PRACH configuration |
| 0 <= Use positioning | The terminal device using group |
| information to calculate | information1 (legacy) |
| the distance to the | |
| serving cell < X(m) | |
| X <= Use positioning | Both the group information(s) can |
| information to calculate | be configured |
| the distance to the | |
| serving cell < Y(m) | |
| Y <= Use positioning | The terminal device using group |
| information to calculate | information0 and at least one of the |
| the distance to the | following is influenced: |
| serving cell < Z(m) | the PRACH format/SCS, |
| | RO ConfigureIndex, |
| | PRACH period |

TABLE 9
PRACH configuration based on positioning information.

| Positioning information to calculate | |
|---|---|
| distance to the serving Cell | PRACH configuration |
| 0 <= Use positioning | The terminal device using group |
| information to calculate | information1 (legacy) |
| the distance to the | |
| serving Cell < X(m) | |
| X <= Use positioning | |
| information to calculate | |
| the distance to the | |
| serving Cell < Y(m) | |
| Y <= Use positioning | The terminal device using group |
| information to calculate | information0 and at least one of the |
| the distance to the | following is influenced: |
| serving Cell < Z(m) | the PRACH format/SCS, |
| | RO ConfigureIndex, |
| | PRACH period |

Tables 10-11 further show how measurement results can be used to determine the PRACH configuration. Tables 8 and 9 showed positioning information (as one example of the measurement results), but there are other examples of reference signals or information that can be used for modifying or establishing the configuration. The new adding symbol number maybe indicated implicitly by the parameter(s), which meet the one of the measurement pool in Table 11.

TABLE 10
PRACH configuration based on measurement
results against a threshold.

| Use measurement results | PRACH configuration |
|---|---|
| Measured RSRP/RSRQ < Threshold | The terminal device using group |
| (the communication node | information0 and at least |
| configured to the | one of the following is |
| terminal device) | influenced: the PRACH |
| | format/SCS, RO |
| | ConfigureIndex, PRACH period |
| Measured RSRP/RSRQ > Threshold | The terminal device using group |
| (the communication node | information1 (legacy) |
| configured to the | |
| terminal device) | |

TABLE 11
PRACH configuration based on measurement
results against a measurement pool.

| Use measurement results | PRACH configuration |
|---|---|
| The parameter(s) meets the one | The terminal device using |
| of the measurement pool, | group information0 and |
| the measurement pool is | at least one of the |
| predefined and/or measured | following is influenced: |
| by AI, which is used for | the PRACH format/SCS, |
| wireless environment | RO ConfigureIndex, |
| characterization. | PRACH period |
| measurement pool0 | |
| the parameter(s) meet the | The terminal device using group |
| one of the measurement pool, | information1 (legacy) |
| the measurement pool | |
| is predefined and/or measured by, | |
| which is used for wireless | |
| environment characterization. | |
| measurement pool 1 | |

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1-35 (canceled)

36. A method for wireless communication, comprising:
determining, by a basestation, a configuration based on at least a first group having legacy information and a second group having new information; and
receiving, by a basestation from a user equipment (UE), a signal during an initial access for establishing communication between the UE and the basestation using the configuration.

37. The method of claim 36, wherein the initial access comprises a Physical Random Access Channel (PRACH) protocol; and the configuration comprises at least one of a preamble for PRACH, a PRACH format, a PRACH subcarrier spacing (SCS), a RACH Occasion Configure Index, or a PRACH period.

38. The method of claim 37, wherein the configuration includes a difference between the first group having legacy information and the second group having new information in at least the PRACH format, the SCS, the RACH Occasion configure index, or the PRACH period.

39. The method of claim 36, further comprising:
transmitting, by the basestation to the UE, the configuration and a reference signal; and wherein
the determination of the configuration is further based on a measurement result of the reference signal or a control signaling indication.

40. The method of claim 39, wherein the reference signal comprises at least one of a primary synchronization signal, a secondary synchronization signal, a channel-state information reference signal, a demodulation reference signal, a phase-tracking reference signal, or a sounding reference signal.

41. The method of claim 39, wherein the measurement result of the reference signal or the control signaling indication is from another communication node or core network, such as beam information, paging information, or positioning information.

42. The method of claim 37, further comprising:
inserting, by the basestation, into an initial access format or preamble format, a time duration; and
forming, by the basestation, an updated initial access format or preamble format that includes the time duration.

43. The method of claim 42, wherein the time duration comprises a change to a gap prefix (GP) or a cyclic prefix (CP), and the change comprises a symbol number.

44. The method of claim 43, wherein the symbol number of the PRACH format is based on a beam information, a paging information, a system information, or a positioning information.

45. The method of claim 39, further comprising:
modifying, by the basestation, the configuration for the initial access based on comparing a threshold, wherein the threshold is configured by the basestation or a high layer parameter and is compared with the measurement result of the reference signal.

46. A method for wireless communication, comprising:
transmitting, by a user equipment (UE) to a basestation, a signal during an initial access;
receiving, by the UE from the basestation, a configuration for the initial access based on at least a first group having legacy information and a second group having new information; and
utilizing, by the UE, the configuration for the initial access for establishing communication between the UE and the basestation.

47. The method of claim 46, wherein the initial access comprises a Physical Random Access Channel (PRACH) protocol; and the configuration comprises at least one of a preamble for PRACH, a PRACH format, a PRACH subcarrier spacing (SCS), a RACH Occasion Configure Index, or a PRACH period.

48. The method of claim 47, further comprising:
receiving, by the UE from the basestation, an updated initial access format or preamble format that includes a time duration, wherein the time duration is inserted into an initial access format or preamble format by the basestation.

49. The method of claim 48, wherein the time duration comprises a change to a gap prefix (GP) or a cyclic prefix (CP), and the change comprises a symbol level.

50. The method of claim 46, further comprising:
receiving, by the UE from the basestation, a reference signal or a control signaling indication; and
reporting, by the UE to the basestation, a measurement result on the reference signal or on the control signaling indication, wherein the configuration is further based on the measurement result.

51. The method of claim 50, further comprising:
receiving, by the UE from the basestation, a modification of the configuration for the initial access based on comparing a threshold, wherein the threshold is configured by the basestation or a high layer parameter and is compared with the measurement result of the reference signal.

52. A wireless communications apparatus comprising a processor and a memory, wherein the processor is configured to read code from the memory and implement the method recited in claim 36.

53. A computer program product comprising a computer-readable program medium code stored thereupon, the code, when executed by a processor, causing the processor to implement the method recited in claim 36.

54. An apparatus for wireless communication, comprising:
a memory storing instructions; and
a processor in communication with the memory, wherein, when the processor executes the instructions, the processor is configured to cause the apparatus to perform:
transmitting, by the apparatus to a basestation, a signal during an initial access;
receiving, by the apparatus from the basestation, a configuration for the initial access based on at least a first group having legacy information and a second group having new information; and
utilizing, by the apparatus, the configuration for the initial access for establishing communication between the apparatus and the basestation.

55. The apparatus of claim 54, further comprising:
receiving, by the apparatus from the basestation, a reference signal or a control signaling indication; and
reporting, by the apparatus to the basestation, a measurement result of the reference signal or of the control signaling indication, wherein the configuration is further based on the measurement result.
